(19) United States
(12) Patent Application Publication
(10) Pub. No.: US 2024/0391688 A1
(43) Pub. Date: Nov. 28, 2024

(54) Device for Securely Storing Liquid Hazardous Material, Corresponding Storage System and Method

(71) Applicant: Minimax Viking Research & Development GmbH, Bad Oldesloe (DE)

(72) Inventors: Jan FEUCHT, Bad Oldesloe (DE); Christof CHETKOWSKI, Bad Oldesloe (DE); Alexander DIETERICH, Bad Oldesloe (DE)

(21) Appl. No.: 18/260,084

(22) PCT Filed: Feb. 11, 2022
(86) PCT No.: PCT/EP2022/053423

§ 371 Date: Jun. 30, 2023

(30) Foreign Application Priority Data
Feb. 12, 2021 (DE) 10 2021 103 328.4

(51) Int. Cl. B65D 90/24; A62C 3/00; B65G 1/04

(52) U.S. Cl. CPC B65D 90/24; A62C 3/002; B65G 1/04; B65D 2590/24

(57) ABSTRACT

A device for securely storing liquid hazardous material. The device includes a housing for receiving a storage container for the liquid hazardous material. The housing has a rear protective wall which is designed to protect a rear side of the storage container, a first and a second side protective wall which are designed to protect two side walls of the storage container, and a front protective wall which is designed to protect a front side of the storage container, and a fluid-permeable platform which is designed as a supporting surface for the storage container within the device, and a collection region which is fluidically connected to an inner region of the housing. The front protective wall is designed to be arranged on the storage container in order, when the storage container is received in the device, to form the housing.

### PRIORITY CLAIM AND INCORPORATION BY REFERENCE

This application is a 35 U.S.C. § 371 application of International Application No. PCT/EP2022/053423, filed Feb. 11, 2022, which claims the benefit of German Application No. 10 2021 103 328.4, filed Feb. 12, 2021, each of which is incorporated by reference in its entirety.

### BACKGROUND AND SUMMARY OF THE INVENTION

The present invention relates to a device for securely storing liquid hazardous material, comprising a housing which is designed to receive a storage container for the liquid hazardous material, the housing comprising a rear protective wall which is designed to protect a rear side of the storage container, a first side protective wall and a second side protective wall which are designed to protect two side walls of the storage container, a front protective wall which is designed to protect a front side of the storage container, and a fluid-permeable platform which is designed as a supporting surface for the storage container within the device, and a collection region which is fluidically connected to an inner region of the housing.

The invention relates in particular to the secure storage and the associated fire protection of liquid hazardous material, particularly flammable liquid hazardous material such as flammable liquids. Flammable liquids are understood to mean liquids that ignite easily in the event of a fire and/or that can be assigned to a hazard class. Flammable liquids are to be understood hereinafter inter alia as being chemicals, solvents, highly volatile liquids, greases, or the like.

It is known from the prior art to store liquid hazardous material in specially designed storage containers. Large storage containers in particular which utilize the available storage space as efficiently as possible and enable the most efficient storage possible in relation to the necessary storage space have proven to be especially advantageous. Large storage containers that utilize storage space efficiently offer the advantage that the hazardous material can be transported much more efficiently and better handled during transport, since the number of large storage containers to be handled is reduced substantially in comparison to smaller storage containers with less capacity.

Intermediate Bulk Containers (IBCs) are one noteworthy example of such storage containers. These storage containers are specially designed and approved for the transportation of hazardous material from one place to another followed by the secure storage thereof. IBCs are usually cuboid containers made of plastic which are often surrounded by a metal frame and have a high filling capacity ranging from 500 to 3000 liters, for example. The metal frame can, in particular, enable the IBCs to be stacked on top of one another and prevent the plastic of the IBC from bulging when it is filled with liquid, in particular with liquid hazardous material. They provide particularly safe and efficient storage because, by virtue of their cuboid shape, they make better use of the available storage space, e.g., the storage space on a pallet, than steel barrels, for example.

According to the invention, such a storage container is to be stored in a corresponding device for secure storage which comprises a housing for the storage container. The term “housing” is intended to refer in particular to a type of casing that surrounds the storage container when it has been received in the housing. For this purpose, the housing comprises at least four protective walls which surround the storage container. The at least four protective walls comprise a front protective wall and a rear protective wall, as well as a first side protective wall and a second side protective wall.

The term “front protective wall” is intended to refer, in particular, to a protective wall that is designed to cover a front side of the storage container on which the outlet opening of the storage container is usually located. In the assembled state, the front protective wall should therefore extend more or less parallel to the front side of the storage container.

Analogously, the term “rear protective wall” should be understood to mean a protective wall that is designed to cover the back side of the storage container. In the assembled state, the rear protective wall should therefore extend more or less parallel to the rear side of the storage container.

Accordingly, the terms “first side protective wall” and “second side protective wall” should be understood to mean the protective walls that are designed to cover the side walls of the storage container. In the assembled state, the first side protective wall and the second side protective wall should therefore extend more or less parallel to the side surfaces of the storage container. In some embodiments, the front protective wall, the rear protective wall, and the first and second side protective walls can be embodied particularly as flat, rectangular, or square components made of a non-combustible material, for example as sheets made of a metal.

The housing can preferably further comprise a fluid-permeable platform. A fluid-permeable platform is to be understood hereinafter to mean a platform that is stable enough to serve as a supporting surface for the storage container while having fluid-permeable properties at the same time, enabling any liquid hazardous material that may emerge from the storage container to be diverted through the fluid-permeable platform. In some embodiments, the fluid-permeable platform can be embodied particularly as a grating.

Preferably, the rear protective wall, the first side protective wall, and the second side protective wall can be connected to one another and to the fluid-permeable platform to form a first subcomponent of the housing.

According to the invention, the device for secure storage further comprises a collection region which is connected to an inner region of the housing in a fluid-conducting manner. An inner region of the housing is to be understood particularly as the area above the fluid-permeable platform in which the storage container is located and which is surrounded by the front protective wall, the rear protective wall, and the first and second side protective walls.

A collection region should also be understood to refer, in particular, to a region in which the liquid hazardous material that has escaped from the storage containers can be collected in order to prevent spreading over the entire storage region. For this purpose, the receiving volume for a fluid of the collection region can be preferably selected such that it can receive the contents of at least one storage container and a specified amount of extinguishing fluid without overflowing. The specified amount of extinguishing fluid can be predetermined particularly on the basis of an amount of extinguishing fluid per unit of time that is dispensed to the collection region.

In some embodiments, the collection region can be embodied particularly as one or more collection troughs. In this connection, the definition that the device comprises the collection region should be understood broadly. In particular, one collection region can be associated with a plurality of devices, so that each of these devices comprises the collection region or a portion thereof.

Alternatively, however, each device can also comprise its own collection region, in which case there is a one-to-one correlation between the collection region and the device. In some embodiments, if the storage assembly comprises multiple levels, a collection trough can also be provided for each level, meaning that any fluid that has escaped from the devices on one level of the storage assembly can be channeled specifically into the collection trough that is associated with the respective level. In some embodiments, a plurality of collection troughs can also be provided for each level which constitute multiple collection regions for the level. In some embodiments, the collection troughs of a level can be connected to one another in a fluid-conducting manner and thus together form a collection region for the level. In some embodiments, the collection troughs that are distributed over the multiple levels can be connected to one another in a fluid-conducting manner and thus form the collection region. In some embodiments, the collection troughs that are arranged exactly one above the other in the multiple levels can also be connected to one another in a fluid-conducting manner and thus form the collection region for a specific portion of the storage assembly. In some embodiments, each device can comprise its own collection trough, in which case the collection troughs of all of the devices that are arranged within a storage assembly can be connected in a fluid-conducting manner and thus form a common collection region. Alternatively, a single collection trough can be provided for all of the devices within a storage assembly. Other arrangements are also conceivable and will become apparent from the following description.

During transport, large storage containers such as IBCs can be transported using pallets and thus arranged in appropriate storage assemblies such as shelves, for example. The transport and subsequent storage of hazardous material, particularly of liquid hazardous material, poses a major challenge in terms of storage safety and fire protection. Particularly in the case of flammable liquids, if they accidentally escape from the storage container, they can spread across the storage region and thus endanger the health of people within the storage region.

Furthermore, a fire in a storage region for liquid hazardous material can lead to a combustion of the liquid hazardous material and, if the spread of the liquid hazardous material is not restricted, to a fire event that spreads over a large area. This makes effective firefighting more difficult. Furthermore, the hazardous material that is already burning can lead to the ignition of other hazardous material that is still within its respective storage containers. This can lead to the very rapid growth of the fire event, making firefighting even more difficult or, if it propagates too quickly, impossible to perform efficiently.

It is therefore desirable to prevent liquid hazardous material from spreading when it escapes from a storage container. In order to prevent such a spread of the liquid hazardous material, it is known to take safety measures to ensure that any hazardous material that might escape from the storage containers is not distributed over a large area. Such safety measures can also include fire protection measures to prevent any fire that might occur in the hazardous material from spreading further.

EP 2 859 919 teaches a device for securely storing a storage container in which the storage container is arranged on a fluid-permeable platform on a collecting container. The collecting container serves to collect the liquid hazardous material that escapes from the storage container and thereby prevent it from spreading. Furthermore, EP 2 859 919 teaches the arrangement of a flame arrester between the collecting container and the storage container which serves as protection against penetration of the flame to the flammable liquid in the collecting container that is to be discharged. In order to seal off individual storage containers from one another and thus prevent other storage containers from being affected in the event of a fire, protective walls are also provided which are arranged between the storage containers.

According to the prior art, the storage containers are usually arranged in devices that are specially designed for this purpose. These devices include a fire protection trough with a flame arrester for each storage container. The fire protection trough serves to collect the hazardous material that has escaped from the storage containers and to contain it to the greatest possible extent. The flame arrester also serves to stop contact with a possible fire source at the storage container.

In order to prevent the liquid hazardous material from spreading into areas outside the interception region of the fire protection trough, such devices can also comprise one or more splash guards that provide splash protection. In the solutions that are known from the prior art, a provision is made in particular to arrange a splash guard on the sides of the storage container and on the rear side of the storage container. Optionally, a movable splash guard can also be provided on the front side—i.e., the extraction side—of the storage container which can be folded up in the event of an actual fire event.

Even if the solutions known from the prior art already very efficiently prevent the spread of hazardous material in the event of a fire and thus enable efficient firefighting, the devices used for this are very large and very difficult to transport. It is therefore difficult to transport the storage container arranged within the device from one place to another. In addition, the devices do not allow the storage container to be arranged in all commercially available storage assemblies, particularly shelves. Finally, the known solutions require that no splash guard be arranged on at least one side of the device during transport and insertion into the device. Since the storage containers are usually arranged in the storage assemblies in the direction of their extraction side—that is, they are arrange d in such a way that the extraction side points in the direction of a gap between two storage assemblies—this means that, when the storage containers are being transported, there is no protection against the hazardous material escaping from the front side, i.e., the extraction side of the storage container. Therefore, the subsequent mounting of the splash guard on the front of the storage container can be cumbersome and dangerous.

Against this background, it is the object of the present invention to improve upon the solutions that are known from the prior art. In particular, it is an object of the invention to provide a device which ensures adequate fire protection for storage containers for hazardous material, particularly liquid hazardous material, while simultaneously ensuring that the storage container can be arranged in a commercially available storage assembly, particularly a commercially available shelf, using a common means of transport.

This object is achieved according to the invention in that the front protective wall is designed to be arranged on the storage container in order to form the housing together with the rear protective wall, the first side protective wall, the second side protective wall, and the fluid-permeable platform when the storage container is received in the device, the front protective wall comprising a transport receiving means which is designed to cooperate with a transport means for the purpose of transporting the storage container.

According to the invention, the intention is that the front protective wall not be installed only after the storage container has been inserted into the device, but rather it should be arranged previously on the storage container and then transported together therewith. This means that, when the storage container is arranged within the storage assembly, particularly on the fluid-permeable platform that is already in the storage assembly, the front protective wall is already located on the storage container. The housing for the storage container is thus formed by inserting the storage container into the storage assembly. The front protective wall can be designed to be connectable to the first side and/or second side protective wall. Alternatively, the housing can also be formed without a connection between the front protective wall and the first and second side protective walls.

The front protective wall should therefore be arranged on the storage container during transport. In this connection, the expression “arranged on the storage container” can mean that the front protective wall is attached to the storage container. Alternatively or in addition, the front protective wall can also be arranged on the storage container by attaching the attachment not to the storage container itself, but to a support surface for the storage container, such as a pallet. Other ways of arranging the front protective wall on the storage container can also be devised. What is crucial is that the front protective wall be able to be moved together with the storage container without changing its position relative to the storage container.

By virtue of this arrangement, the front protective wall offers protection on the extraction side or front side of the storage container during transport. On the one hand, this protects against the hazardous material accidentally escaping onto the transport device; on the other hand, this avoids the circumstances and dangers of subsequently installing the front protective wall after it has been arranged within the storage assembly. A further advantage lies in the fact that the front protective wall protects the storage container during transport to a certain extent against possible damage caused by the means used to transport the transport device, such as the fork tips of a forklift.

According to the invention, in order to enable the storage container to be transported together with the front protective wall, the front protective wall should have a transport receiving means.

A transport receiving means is to be understood here particularly as a device in the front protective wall that ensures that the storage container can be transported by conventional means of transport, such as the forks of a forklift, even after arrangement of the front protective wall. The transport receiving means should therefore be designed to interact with such means of transport for the purpose of transporting the storage container.

The term “transport” or “transporting” should be understood broadly in this connection. The transporting of the storage container can only involve lifting and/or setting down. Alternatively or in addition, transporting can also include moving and/or rearranging the storage container. The term “transport” includes, in particular, any movement of the storage container from an original position. In some embodiments, transporting can serve the particular purpose of arranging the storage container in a storage assembly such as a shelf together with the front protective wall.

In some embodiments, the housing may further comprise an upper protective wall that is designed to protect a top side of the transport container after the transport container has been inserted. In some embodiments, this upper protective wall can comprise an inlet opening for admitting extinguishing fluid from a corresponding extinguishing fluid outlet.

In some embodiments, the device may further comprise a heat protection element which can be embodied, for example, as a heat protection plate. It is possible here for the heat protection element to be designed, in particular, to protect the front protective wall, the rear protective wall, the first and the second side protective wall, the fluid-permeable platform, and/or other components of the device, as well as parts of the storage assembly, from heat if an ascending fire event occurs. The heat protection element can also serve the purpose of conducting the heat away from a specific area and thereby protecting it. In some embodiments, the heat protection element can comprise an opening for admitting extinguishing fluid from a corresponding extinguishing fluid outlet.

In some embodiments, it can also be advantageous to provide additional heat protection measures for the device with the storage container and/or the storage assembly. If a fire event occurs, heat is generated by this fire event which can radiate in particular upwards, i.e., along a direction that leads away from a floor surface on which the storage assembly with the devices is arranged, and forward, i.e., along a direction leading out of the storage assembly away from the device. Furthermore, lateral radiation can also occur. This heat, in turn, can cause the liquid hazardous material in another storage container to ignite, in particular, a storage container that is arranged in the storage assembly above the storage container in which the fire event occurred. To prevent this, further heat protection measures can be provided as an alternative or in addition to the heat protection elements.

As one possible heat protection measure, the distance between the storage containers on different levels of the storage assembly could be increased, for example. Alternatively or in addition, the distance between storage containers arranged next to one another could also be increased. Such an increase in the distance between individual storage containers can be achieved particularly by modifying the storage assembly. For example, the storage assembly can be changed such that there is a greater distance than usual between the individual levels. Alternatively or in addition, the storage assembly could be modified such that a greater distance is created between the storage columns, thus enabling a greater distance to be provided between the storage containers even with a comparable number of them arranged next to one another. This greater distance means that the heat between the individual storage containers is better distributed and therefore reduced. This can reduce the risk of the liquid hazardous material igniting in other storage containers.

Another possible heat protection measure can also consist in arranging additional insulation material on the device and/or storage assembly. In some embodiments, this additional insulation material can comprise an additional damping material, for example. Mineral wool is worth mentioning here as a damping material that can be used advantageously for these purposes. But comparable damping materials are also conceivable for this application.

In some embodiments, the damping material can be arranged particularly on the storage assembly. In that case, the damping material can preferably be arranged in a plane of the storage assembly on which the storage containers can be arranged. In some embodiments, the damping material can be arranged particularly on the underside of such a level in such a way that it is situated opposite the devices with the storage containers arranged on the subjacent level. This can be done particularly for all levels of the storage assembly. If the liquid hazardous material ignites in one of these storage containers, the damping material can dampen—i.e., reduce—the heat that might radiate to the devices located above. In some embodiments, the damping material can also be arranged on the top of the levels of the storage assembly, meaning that the device is, as it were, placed on the damping material. In that case, the damping material can also dampen the rising heat and thereby protect the storage container that is standing on the damping material within its device from the radiated heat.

The damping material can also be arranged on the device, preferably on the top and/or front of the device, particularly on the upper protective wall and/or front protective wall. It is also conceivable to arrange the damping material on the first and/or second side and/or on the rear protective wall. Alternatively or in addition, the damping material can also be arranged on the fluid-permeable platform.

In some embodiments, an adhesive, foamable seal can also be used as an alternative or in addition to a damping material. One example of such a foamable seal that is noteworthy in this connection is a seal from the Promaseal series of the manufacturer Promat.

Such a seal can also preferably be provided, particularly glued, on every level of the storage assembly on which the storage containers can be arranged. The seal can be preferably glued to the underside of the levels. Alternatively or in addition, it is also conceivable for the seal to be glued the top of the levels, enabling the storage containers to be placed on the seal in their device. If the liquid hazardous material ignites in one of the storage containers, the resulting heat causes the seal to foam, which creates a greater spatial distance and forms a foam crust which then acts as a seal against the heat and thus also protects the other storage containers in the other devices in the storage assembly.

The foaming seal can of course also be arranged directly on the device, particularly on the front and/or rear and/or first and/or second protective wall and/or on the fluid-permeable platform of the device and provide heat protection in that manner.

In some embodiments, as an alternative or in addition, a fireproof paint can also be arranged on the device and/or storage assembly. Such fireproof paint is solid like an ordinary paint at normal temperature. However, if heat occurs, particularly due to a fire, the fireproof paint foams and creates an insulating layer.

In some embodiments, the fireproof paint can be applied particularly to the storage assembly for that purpose. Preferably, the fireproof paint can be provided on the bottom of each level of the storage assembly so as to dampen heat rising from a storage container located on the level located below and prevent it from reaching the storage containers on the levels above. In some embodiments, however, the fireproofing paint can also be provided on the top of each level of the storage assembly, enabling the storage containers to be placed on the levels provided with fireproofing paint in their devices. It may also be preferred to additionally or alternatively apply the fireproof paint to structurally weak areas of the storage assembly. A structurally weak area of the storage assembly is understood to mean an area that is substantially less resistant to the effects of high loads and/or high pressure and/or high heat compared to the rest of the storage assembly. One noteworthy example of such a structurally weak area is the mounting brackets for the plates of the storage assembly forming the individual levels of the storage assembly on the storage columns. This provides additional protection for these structurally weak areas in the event of a fire.

In some embodiments, the fireproof paint can be attached to the device for this purpose, particularly to the first and/or second side protective wall and/or to the front protective wall and/or rear protective wall and/or to the fluid-permeable one.

The device can preferably further comprise at least one discharge surface which is designed to provide at least part of a fluid-conducting connection between the inner region of the housing and the collection region.

The term “discharge surface” should be understood broadly. On the one hand, a discharge surface can be understood as a surface that is designed to channel the liquid hazardous material that has escaped from the storage container toward the collection region. On the other hand, the term “discharge surface” can also be understood as a type of discharge trough which can be designed to first collect the liquid hazardous material that has escaped from the storage container and then channel it toward the collection region. In some embodiments, the discharge surface can have an incline and/or a slope for this purpose. Alternatively or in addition, the discharge surface can also have a plurality of inclines and/or slopes and/or a conical shape. In some embodiments, these can be embodied such that the liquid hazardous material can be channeled to a specific point.

In some embodiments, the receiving volume of the discharge surface for the liquid hazardous material can be selected so as to be sufficiently large that the discharge surface can act as a buffer for the liquid hazardous material if it suddenly emerges in large quantities from the storage container and the fluid conduit is no longer able to handle the amount of suddenly escaping liquid hazardous material in the direction of the collection region.

In some embodiments, a plurality of discharge surfaces can also be provided per storage container which can then together form a discharge area.

In some embodiments, the device may further comprise at least one fluid conduit system which can be configured so as to provide at least part of a fluid-conducting connection between the inner region of the housing and the collection region. It may be preferred here that one or the at least one discharge surface have a slope in the direction of the fluid conduit system in order to conduct a fluid in the direction of the fluid conduit system.

As mentioned above, the inner region of the housing, into which the liquid hazardous material that has escaped from the storage container first enters, and the collection region, which serves to collect the liquid hazardous material that has escaped, can be connected to one another in a fluid-conducting manner. In some embodiments, this fluid-conducting connection can be provided at least in part by a fluid conduit system. A fluid conduit system can be understood in particular as being an arrangement that is able to conduct, in a targeted manner in the direction of the collecting basin, the liquid hazardous material and/or an additional fluid, such as an extinguishing fluid, that has emerged from corresponding extinguishing fluid outlets. In some embodiments, the fluid conduit system can in particular be provided at least partially by corresponding fluid-conducting pipes and/or other fluid-conducting cavities.

The use of a fluid conduit system can be advantageous particularly if the storage containers are arranged at higher levels of the storage assembly.

It may be preferred that the at least one discharge surface be designed such that the extinguishing fluid that has emerged from the storage containers can be conducted in the direction of the fluid conduit system. For this purpose, the at least one discharge surface can, in particular, have a slope in the direction of the fluid conduit system. This means that at least part of the discharge surface can have an incline that is designed to guide a fluid located on it toward the fluid conduit system. This enables the liquid hazardous material to be discharged more efficiently into the collecting basin.

In some embodiments, the front protective wall may further comprise at least one side guard which is designed to extend along at least one side surface of the storage container.

In some embodiments, the front protective wall can be provided with at least one side guard which can be designed to cover at least a portion of a side surface of the storage container on which the front protective wall is arranged. Preferably, the front protective wall can comprise a first side guard and a second side guard—i.e., a respective side guard for each side of the storage container.

The at least one—first and/or second—side guard can extend more or less orthogonally to a surface that is formed by the main surface of the front protective wall and can therefore be more or less parallel to the side surface of the storage container and thus also extend more or less parallel to the first or second side protective wall when the storage container is arranged in the storage assembly together with the front protective wall. Here, the at least one side guard can completely or partially cover the side surface of the storage container. In some embodiments, the at least one side guard can cover at least an area of from ⅓ to ⅔ of the side surface, preferably an area of from ⅓ to ½ of the side surface of the storage container.

The advantage of this embodiment lies in an improvement in the protection provided by the front protective wall during transport and/or storage of the storage container in the event of liquid hazardous material escaping from the storage container, since the at least one side guard protects against escaping to the side.

In some embodiments, one or more from among the rear protective wall, the first side protective wall, the second side protective wall, the front protective wall, and the fluid-permeable platform can be made of a non-combustible material.

It is preferred that one or more components of the housing—i.e., the rear protective wall, the front protective wall, the side protective walls, and/or the fluid-permeable platform—can be made of a non-combustible material. In this context, a non-combustible material can be understood to refer, in particular, to a material that is non-combustible or can only be ignited with great difficulty. In some embodiments, this non-combustible material comprises, in particular, a metal. In some embodiments, the front protective wall, the rear protective wall, and the side protective walls can, in particular, be formed from a flat, rectangular, or square component such as a (metal) sheet, and the fluid-permeable platform can be embodied as a grating, particularly a metal grating.

In some embodiments, the material or materials that are selected for the components can be resistant to the liquid hazardous material. The term “resistant to the liquid hazardous material” should be understood in particular to mean that the materials are not corroded at all by the liquid hazardous material or only with great difficulty. In some embodiments, the materials for the device can therefore also be selected based on the liquid hazardous material that is to be stored.

In some embodiments, the device may further comprise at least one first flame arrester, in which case the at least one first flame arrester is arranged between the fluid-permeable platform and the collection region. In some embodiments, the device may further comprise at least one second flame arrester, in which case the at least one second flame arrester can be arranged between the fluid-permeable platform and the at least one discharge surface. In another refinement, at least one from among the first flame arrester or the second flame arrester can be embodied as a siphon and/or as a grate.

In some embodiments, the device can also comprise a first or a second flame arrester. A flame arrester is to be understood in particular as an arrangement that prevents flame penetration from one side of the flame arrester to the other. Through the use of flame arresters, a fire event can be limited to a relatively small area within the device.

In some embodiments, the containment area can comprise at least one first flame arrester. This at least one first flame arrester can serve to prevent a fire event occurring within the collection region from spreading to the areas above or next to it, for example to the discharge surface and/or the fluid conduit system. On the other hand, the at least one first flame arrester can also prevent a fire event occurring on the discharge surface, for example, from reaching the collection region. For this purpose, the at least one first flame arrester can be arranged within the collection region in such a way that it represents a flame suppression barrier between at least one location of a potential fire event and a location to be protected. The at least one first flame arrester can be arranged particularly in the form of a flame arrester between the collection region and the discharge surface and/or between the collection region and the fluid conduit system.

In some embodiments, the discharge surface can comprise at least one second flame arrester. This at least one second flame arrester can be used in particular to prevent a fire event occurring within the discharge surface from spreading to the areas above or next to it, for example to the fluid conduit system and/or storage container. Conversely, the at least one second flame arrester can also prevent a fire event occurring, for example, in the inner region of the housing—i.e., around the storage container—from reaching the discharge area. For this purpose, the at least one second flame arrester can be arranged within and/or on the discharge surface in such a way that it represents a flame suppression barrier between at least one location of a potential fire event and a location to be protected. The at least one second flame arrester can be arranged in particular as a flame arrester between the discharge surface and the storage container or inner region and/or between the discharge surface and the fluid conduit system.

For this purpose, the at least one first and/or the at least one second flame arrester can be configured in particular in such a way that the liquid hazardous material and/or the extinguishing fluid and/or additional fluid located within the housing are able to pass through the respective—at least one first and/or second—flame arrester while simultaneously enabling heat dissipation to occur from the liquid hazardous material and/or the extinguishing fluid and/or the additional fluid to the material of the at least one first and/or at least one second flame arrester. This can preferably be achieved by the at least one first and/or the at least one second flame arrester have a ratio between fluid-permeable areas and heat-dissipating areas, which enables effective heat dissipation from the respective fluids. The dissipation of heat from the liquid hazardous material and/or the extinguishing fluid and/or any additional fluid can result in a fire event being extinguished in the liquid hazardous material and/or extinguishing fluid and/or any additional fluid, with the fluid permeability of the at least one first and/or at least one second flame arrester ensuring that the respective fluid can continue to reach the collection region of the device after the fire has been extinguished.

Here, the at least one first and/or the at least one second flame arrester can be embodied particularly in the form of a siphon. Alternatively or in addition, a design in the form of a grate can also be provided. In some embodiments, the at least one first flame arrester and/or the at least one second flame arrester can also be embodied as a wire mesh, particularly a stainless steel wire mesh. Alternatively or in addition, the at least one first flame arrester and/or the at least one second flame arrester can also be made of mineral wool and/or glass wool. In some embodiments, the at least one first flame arrester and/or the at least one second flame arrester can also be embodied as a plate, for example as a metal plate, into which corresponding small slots are formed. Further alternative or additional embodiments are conceivable.

In some embodiments, the collection region can have a first intake volume, V_{AU}, with the first intake volume being determinable as

$${V}_{AU} = {V}_{L} + {V}_{S} ,$$

where V_{L} can correspond to a storage volume of the storage container and V_{S} can correspond to a specified safety volume. In another refinement, the at least one discharge surface can have a second intake volume V_{AL}, with the second intake volume being smaller than the first receiving volume (V_{AL}<V_{AU}).

In some embodiments, it may be preferred that the collection region have an intake volume—i.e., a holding capacity—that enables the contents of a complete storage container in addition to a certain amount of extinguishing fluid to be received. This is intended to make it possible to prevent the containment area from overflowing in the event of a fire and thus prevent the (burning) liquid hazardous material from spreading. The storage volume—i.e., the holding capacity—of the storage container can first be determined for this purpose. In the case of a commercially available IBC, this storage volume may correspond to 1000 liters, for example.

A safety volume can then be added to this storage volume. This safety volume can preferably correspond to a volume of an extinguishing fluid that can be applied to the device from corresponding extinguishing fluid outlets within a certain period of time in the event of a fire. This period can be identified particularly as the amount of time that is required to initiate further firefighting measures, for example by calling the fire department. The necessary safety volume can be determined on the basis of the known output quantity of the extinguishing fluid outlets per unit of time and the time that is usually required to initiate further firefighting measures. For example, if one assumes a period of 20 minutes until the fire department arrives and that 20 liters of extinguishing fluid are released from the extinguishing fluid outlets onto the device per minute, the safety volume should be 400 liters.

Based on the sum of the storage volume and the safety volume, the receiving volume of the receiving region can then be determined, which corresponds to 1400 liters in the example mentioned above.

The dimensions of the receiving region can then be selected such that the required receiving volume is achieved. This can make it possible to collect the liquid hazardous material together with any extinguishing fluid that may have been applied thereto completely in the receiving region, at least for a certain period of time, and thus prevent overflow and hence the spread of the liquid hazardous material and/or the fire event across the storage region.

In some embodiments, one or more from among the first side protective wall and the second side protective wall can be double-walled with an interposed cavity, the cavity being designed to form at least a portion of the fluid conduit system, and the cavity being further designed to conduct extinguishing fluid that has escaped from the storage containers in the direction of the collection region and/or of the at least one discharge surface.

In some embodiments, the first side protective wall and the second side protective wall can have a double-walled design, so they can each comprise a first wall and a second wall. A cavity can thus be formed between the first wall and the second wall of the first side protective wall. Likewise, a cavity can be formed between the first wall and the second wall of the second side protective wall. Here, the distance between the first wall and the second wall of the first side protective wall and the distance between the first wall and the second wall of the second side protective wall can be selected such that the area cross section of the cavities corresponds to the area cross section of a pipe that is used in other embodiments for the fluid conduit system.

In some embodiments, the double-walled first side protective wall and the double-walled second side protective wall can each have an inlet opening which can be designed to introduce a fluid, in particular the liquid hazardous material, into the respective cavities as well as an outlet opening which can be designed to output the fluid located in the cavities in the direction of the collection region and/or in the direction of another cavity of another device.

In some embodiments, the first side protective wall and the second side protective wall can be arranged particularly on the sides of the discharge surface, which can also have corresponding fluid outlet openings that can be arranged so as to cooperate with the inlet openings in the cavities of the side protective walls in order to transport the liquid hazardous material in the direction of the collection region. This arrangement can thus make it possible to conduct the liquid hazardous material over multiple levels of the storage assembly through a fluid conduit system formed by the cavities in the side protective walls in the direction of a collection region without the need for additional pipes.

In some embodiments, the fluid conduit system formed in this manner can also have one or more connecting elements which can be designed to connect the cavities of the side protective walls to the respective discharge surfaces in a fluid-tight manner. The connecting elements supporting surface embodied as flexible plug-in connections which can only be arranged in the cavities and/or in the discharge surface without being firmly connected thereto. This allows the flexibility of the storage assembly to be retained even after connection using the connecting elements, which reduces the likelihood of damage when heavy loads are applied.

In some embodiments, the rear protective wall can optionally also have a double-walled design with an interposed cavity. In that case, the rear protective wall can be designed analogously to the first side protective wall and/or the second side protective wall and can therefore have a cavity which can be designed to form at least part of the fluid conduit system and to conduct extinguishing fluid that has escaped from the storage containers in the direction of the collection region and/or of the at least one discharge surface.

The above embodiments have the advantage that no additional and/or no complete additional fluid conduit system need to be provided in them, because the first and/or the second side protective wall—and optionally also the rear protective wall—make the fluid conduit possible.

Another advantage of this double-walled design of the first and/or the second side protective wall and/or the rear protective wall is that this design improves thermal insulation. If heat arises, it can be better isolated by virtue of the double-walled design. This makes it possible, for example, for the elements of the storage assembly, particularly of the shelf arrangement in which the storage containers can be arranged, to be better protected against heat.

In another aspect, the invention relates to a storage system for storing liquid hazardous material comprising a plurality of devices according to at least one of the embodiments described above and to a storage assembly which is designed to receive the plurality of devices for storage. In some embodiments, two or more of the plurality of devices can comprise at least one first side protective wall and one second side protective wall which are designed to protect two side walls of a corresponding storage container, it being possible for one or more from among the first side protective wall and the second side protective wall to have a double-walled design with an interposed cavity, the cavity being designed to form at least part of the fluid conduit system, the cavity also being designed to conduct extinguishing fluid that has escaped from the storage containers in the direction of the collection region and/or of the at least one discharge surface, as well as a storage assembly which is designed to receive the plurality of devices for storage, with at least one first device from among the plurality of devices being arranged relative to a floor surface above a second device from among the plurality of devices, the storage system comprising at least one connecting element which is designed to connect the discharge surface of the first device to the cavity of the second device in a fluid-tight manner.

In this variant, the fluid conduit system may not be formed entirely by additional pipes, but at least partially by the cavities in the first and second side protective walls. This offers the advantage that the number of components for the storage system can be reduced while simultaneously reducing the space required for the storage system.

In yet another aspect, the invention relates to a fire protection system comprising at least one storage system which comprises at least one device according to at least one of the embodiments described above, at least one extinguishing fluid supply with at least one extinguishing fluid supply line, and a plurality of extinguishing fluid outlets, the plurality of extinguishing fluid outlets being designed to output an extinguishing fluid to the at least one device in the event of a fire.

In another aspect, the invention further relates to a method for storing a device for securely storing liquid hazardous material, comprising the following steps: providing a housing which is designed to receive a storage container for the liquid hazardous material, the housing comprising a rear protective wall which is designed to protect a rear side of the storage container, a first side protective wall and a second side protective wall which are designed to protect two side walls of the storage container, a front protective wall which is designed to protect a front side of the storage container, and a fluid-permeable platform which is designed as a supporting surface for the storage container within the device, and providing a collection region which is connected in a fluid-conducting manner to an inner region of the housing. The method further comprises the steps: arranging the front protective wall on the storage container, transporting the storage container together with the front protective wall to a storage position by means of a transport means which cooperates with a transport receiving means of the front protective wall and forming the housing through the front protective wall together with the rear protective wall, the first side protective wall, the second side protective wall, and the fluid-permeable platform by inserting the storage container with the front protective wall arranged thereon into the device.

Although the preferred embodiments of the invention have been explained above in connection with the aspect of the device for secure storage, it should be understood at this point that the preferred embodiments also correspond equally to preferred embodiments of the other aspects of the invention, which have not been presented again in detail only in order to avoid repetition.

### BRIEF DESCRIPTION OF THE DRAWINGS

The invention will be described in greater detail below on the basis of preferred exemplary embodiments with reference to the enclosed figures. Brief description of the figures:

FIG. 1 shows a schematic layout of a device for securely storing liquid hazardous material according to a first embodiment,

FIG. 2A shows a first perspective view of a device for securely storing liquid hazardous material according to the first embodiment,

FIG. 2B shows a second perspective view of a device for securely storing liquid hazardous material according to the first embodiment,

FIG. 3 shows a schematic front view of a front protective wall according to the first embodiment,

FIG. 4 shows a schematic layout of a device for securely storing liquid hazardous material according to a second embodiment,

FIG. 5 shows a schematic layout of a device for securely storing liquid hazardous material according to a third embodiment,

FIG. 6A shows a schematic rear view of a front protective wall according to the third embodiment,

FIG. 6B shows a schematic front view of a front protective wall according to the third embodiment, and

FIG. 7 shows a schematic representation of a connecting element according to the third embodiment.

### DETAILED DESCRIPTION OF THE INVENTION

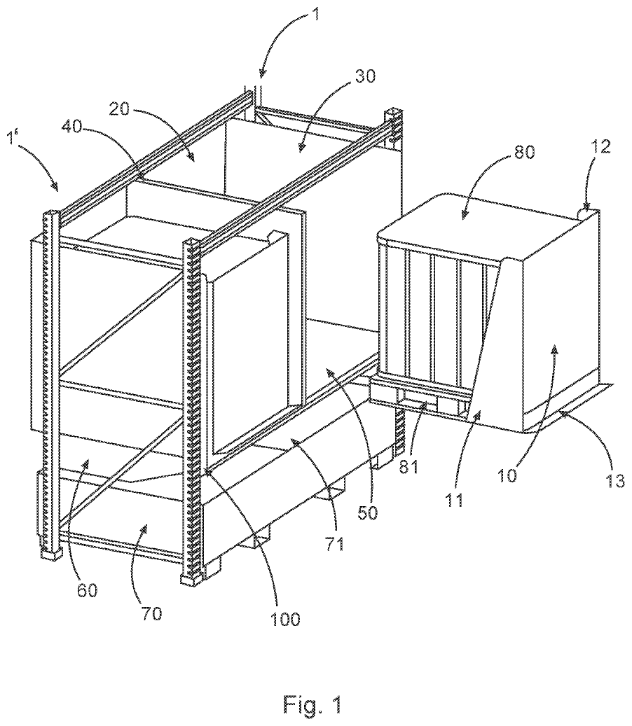

FIG. 1 shows a schematic and exemplary view of two devices 1, 1′ for securely storing liquid hazardous material in a first embodiment. For better illustration, a first device 1 is shown in FIG. 1 which is not arranged in a storage assembly 100 for receiving the devices 1, 1′, and a second device 1′ is shown which is already arranged in the storage assembly 100.

The device 1 is used for securely storing a container 80. For this purpose, the device 1 comprises a rear protective wall 20 which is designed to protect a rear side of the storage container 80 when the storage container 80 is arranged in the storage assembly 100, as is shown in connection with the device 1′. Furthermore, the device 1 comprises a first side protective wall 30 and a second side protective wall 40, each of which is designed to protect two side walls of the storage container 80 when it is arranged in the storage assembly 100, as is shown as an example for the device 1. The rear protective wall 20, the first side protective wall 30, and the second side protective wall 40 are made of a non-combustible material. In the specific embodiment of FIG. 1, the rear protective wall 20, the first side protective wall 30, and the second side protective wall 40 are embodied as sheet metal parts. Sheet metal has the advantage that it is both non-combustible while also being easy to process.

The device 1 further comprises a fluid-permeable platform 50 which is designed as a supporting surface for the storage container 80. The fluid-permeable platform 50 thus serves the purpose of providing a place for the storage container 80 to be supported on when the storage container 80 is arranged in the storage assembly 100. In the specific embodiment of FIG. 1, the fluid-permeable platform 50 is embodied particularly as a grating. The design as a grating means that the fluid-permeable platform 50 can carry the load of a filled storage container 80 while simultaneously making it possible, in the event that liquid hazardous material escapes from the storage container 80, to conduct it toward a discharge surface 60, as will be described in greater detail below.

The storage container 80 can be arranged directly on the fluid-permeable platform or onto an additional transport and/or arrangement platform, which in such a case should also be fluid-permeable. In the first embodiment of FIG. 1, the storage container 80 is arranged on an additional transport and/or arrangement platform which is embodied in the form of a pallet 81.

The device 1 further comprises a front protective wall 10 which is designed to protect a front side of the storage container 80. The front protective wall 10 is also preferably made of a non-combustible material. The front protective wall 10 is arranged on, particularly fastened to, the storage container 80 and can be lifted and transported together with the storage container 80. This means that the protective wall 10 protects the front of the storage container 80 before the storage container 80 is arranged in the storage assembly 100. This allows for the safe transport of the storage container 80, since liquid extinguishing fluid is prevented from escaping in the direction of the means of transport being used. Furthermore, cumbersome and dangerous assembly of the protective wall 10 after arrangement of the storage container 80 in the storage assembly 100 is avoided. Finally, the already-assembled front protective wall 10 protects the storage container 80 during transport to a certain extent against possible damage caused by the means of transport (not shown in FIG. 1) of a transport device (also not shown in FIG. 1), such as the tips of a forklift truck.

In the specific embodiment of FIG. 1, the front protective wall 10 further comprises a first side guard protection 11 and a second side guard 12 which extend approximately orthogonally to the front protective wall 10. The first side guard 11 and the second side guard 12 serve to collect the liquid hazardous material that may be escaping from a side region of the storage container 80 and, in particular, to prevent the escaping liquid hazardous material from forming a jet towards the front and/or to the sides of the storage container 80, which could cause the liquid hazardous material to splash and/or escape to the front side. The storage container 80 is thus even better protected against leakage of the liquid hazardous material.

In the specific embodiment of FIG. 1, the front protective wall 10 is embodied in the form of a sheet metal which initially extends parallel to the front of the storage container 80 and further comprises a first side guard 11 and a second side guard 12 which are orthogonal to the front side guard 10 and thus extend parallel to the side walls of the storage container 80. The sheet metal, which serves as a front protective wall 10, is guided laterally backward around the storage container 80. Alternatively, it is also possible to design the front protective wall 10 and the first side guard 11 and/or the second side guard 12 as three separate components, particularly three separate sheets, i.e., to mount the first side guard 11 and the second side guard 12 as individual sheets on one sheet which forms the front protective wall 10.

Here, the first side guard 11 and the second side guard (not shown in FIG. 1) are set up in the specific embodiment of FIG. 1 such that they only partially cover the side walls. This embodiment is based on the insight that the flammable liquid hazardous material which may be escaping from the storage container 80 is more extensive in the lower region of the storage container 80 than in the upper region due to the higher static pressure. For that reason, it is necessary to guide the first side guard 11 and the second side guard 12 over a larger extent of the storage container 80 in this lower region. The further up the region along the storage container 80 is situated as viewed from a floor surface, the lower the pressure is, so that the first side guard 11 and the second side guard 12 can be made smaller in these areas in order to save weight and material. In some embodiments, the first side guard 11 and the second side guard 12 can particularly have a triangular shape.

In the specific embodiment of FIG. 1, the front protective wall 10 also has a transport receiving means 13 which, in the first embodiment according to FIG. 1, is embodied as a stable sheet metal. The transport receiving means 13 extends from the plane formed by the front protective wall 10 along a direction opposite the direction along which the first side guard 11 and the second side guard 12 extend. In the assembled state, the transport receiving means 13 is therefore outside of an inner region of the housing and extends away from the same.

The transport receiving means 13 is provided with a certain bevel, as will be explained in greater detail below. This bevel has the effect that a transport device such as a forklift can be guided with a corresponding means of transport, for example a transport fork, over this surface beneath the storage container 80, for example into the receptacles of the pallet 81, and thus be moved beneath the storage container 80 for the purpose of lifting and/or moving.

In the specific embodiment of FIG. 1, the storage container 80 on the pallet 81 is arranged in the storage assembly 100 together with the front protective wall 10. When arranged in this manner, the front protective wall 10, the rear protective wall 20, the first side protective wall 30, and the second side protective wall 40 form a housing for the storage container 80 as shown in FIG. 1 in connection with the device 1′. This housing makes it possible to collect liquid hazardous material escaping from the storage container 80 if the storage container 80 is damaged and, in particular, prevent it from escaping from the storage assembly 100 in an uncontrolled manner. This collection can occur both when the liquid hazardous material has merely escaped or when a fire has occurred, i.e., if the liquid hazardous material has already ignited. The liquid hazardous material can then be drained from the housing through the fluid-permeable platform 50.

For this purpose, the device 1 further comprises a discharge surface 60 which, in the specific embodiment of FIG. 1, is designed as a discharge trough 60. The discharge surface 60 is arranged beneath the fluid-permeable platform 50 in order to be connected thereto in a fluid-conducting manner. The liquid hazardous material that has escaped from the storage container 80 into the housing is thus conducted to the discharge surface 60 via the fluid-permeable platform 50. The discharge surface 60 is designed to catch and collect the liquid hazardous material and thereby buffer it to a certain extent, and then to channel it to a fluid conduit system, as will be explained in greater detail in connection with the appended figures.

The leaked hazardous material is then conducted into a collection region 70 via the fluid conduit system. In the specific embodiment of FIG. 1, the collection region 70 is embodied as a collection trough, with one collection trough 70 being provided per storage assembly 100. In other embodiments, however, multiple or fewer collection regions 70 per storage assembly 100 can also be provided—for example, one collection region 70 per device 1, 1′, or one collection region 70 per level of the storage assembly.

In the specific embodiment of FIG. 1, the collection region 70 comprises a first flame arrester 71. This first flame arrester 71 has the effect that, if the liquid hazardous material has ignited on the way to the collection region, the resulting flames cannot penetrate toward the collection region 70, which could cause the fire to spread.

The collection region 70 according to the embodiment of FIG. 1 has a first intake volume V_{AU} which is determined as

$${V}_{AU} = {V}_{L} + {V}_{S} ,$$

where V_{L} corresponds to a storage volume of the storage container 80 and V_{S} corresponds to a specified safety volume. This safety volume corresponds particularly to a volume of an extinguishing fluid that arises at a specific rate of output, i.e., a specific output volume per unit of time.

In other words, the intake volume V_{AU} is selected so as to be large enough to receive, in addition to the contents of the storage container 80, the amount of extinguishing fluid emerging from the extinguishing fluid outlets during firefighting and continues to emerge until further firefighting measures are initiated, for example by the fire department. In the specific embodiment of FIG. 1, it was assumed that 20 minutes might pass before the fire department arrived, with 20 liters of extinguishing fluid being released from the extinguishing fluid outlets into a specific collection region 70 every minute. This means that the collection region 70 should be able to receive another 400 liters of extinguishing fluid, i.e., a total of 1400 liters, in addition to the filling volume of the storage container 80, for example 1000 liters.

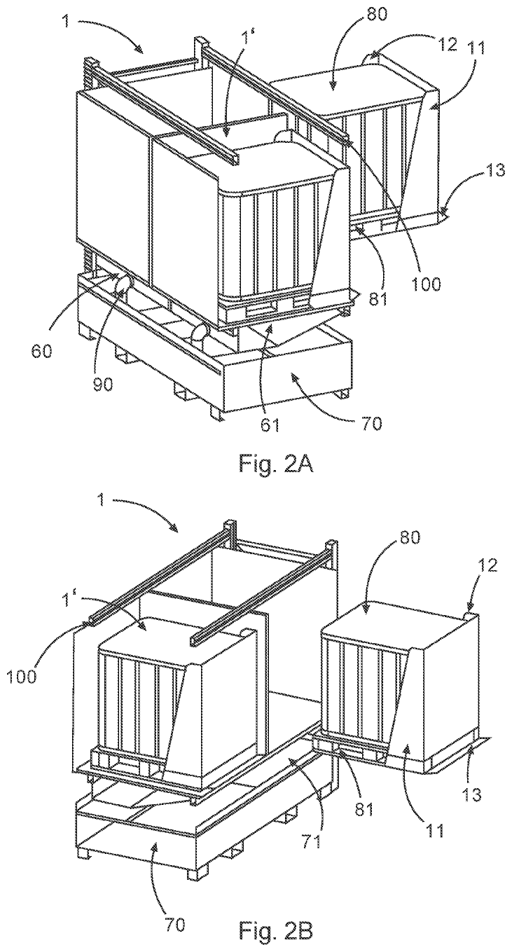

FIGS. 2A and 2B show exemplary and schematic devices 1, 1′ for securely storing a storage container 80 in a first perspective view and a second perspective view. For better illustration, the first side guard of the device 1′ is not shown in the illustration of FIGS. 2A and 2B. FIGS. 2A and 2B show that the storage container 80 is completely surrounded by the housing after it has been inserted into the storage assembly 100, of which only a partial representation is also shown. The functionality and relationships of the embodiment of FIGS. 2A and 2B correspond to those of FIG. 1, with same reference numbers identifying same components. As regards the general functioning of the devices 1, 1′, reference is made to FIG. 1.

The rear side of the storage system, made up of the storage assembly 100 and devices 1, 1′, is shown schematically in the perspective view according to FIG. 2A. The storage system has a fluid conduit system 90 on its rear side which connects the discharge surface 60 to the collection region 70 in a fluid-conducting manner. As further illustrated by FIG. 2A, the discharge surface 60 in the specific first embodiment comprises an inclined surface 61 which has a slope in the direction of the fluid conduit system 90.

If liquid hazardous material now reaches the discharge surface 60, it is channeled through the inclined surface 61 in the direction of the fluid conduit system 90. The fluid conduit system 90 receives the liquid hazardous material and then conducts it into the collection region 70, where the liquid hazardous material is collected. If the liquid hazardous material is ignited, the liquid hazardous material in the collection region 70 can also be extinguished by applying appropriate extinguishing fluid from extinguishing fluid outlets. In order to ensure that the resulting hazardous material/extinguishing fluid mixture is not distributed over a larger region within the storage region, the collection region 70, as described above, has a intake volume that is sufficient to contain the entire contents of the storage container 80 and the extinguishing fluid that emerges from the extinguishing fluid outlets over a certain period of time.

The discharge surface 60 should preferably serve as a buffer here in the event that a large amount of liquid hazardous material suddenly emerges from the storage container 80. To this end, the intake volume of the discharge surface 60 is selected so as to be correspondingly large, so that the leaked liquid hazardous material can first accumulate on the discharge surface 60 and can then be drained off bit by bit via the fluid conduit system 90.

FIG. 2B shows a perspective, schematic view of the front side of the storage system, which is made up of the storage assembly 100 and devices 1, 1′. This perspective view once again illustrates the arrangement of the devices 1, 1′ within the storage assembly 100. Furthermore, a side wall of the collection region 70 is not shown in the perspective view of FIG. 2B. This once again illustrates the spatial relationship between the collection region 70 and the first flame arrester 71. As shown in FIG. 2B, the first flame arrester 71 is arranged in the upper region of the collection region 70. The liquid hazardous material that is conducted into the collection region 70 via the fluid conduit system 90, as well as any extinguishing fluid emerging from the extinguishing fluid outlets, can thus accumulate beneath the first flame arrester 71. For this purpose, the first flame arrester 71 can be designed in particular to be permeable to fluid, thereby enabling the extinguishing fluid to pass through the first flame arrester 71 into the collection region 70. In the first embodiment according to FIGS. 1, 2A, and 2B, the first flame barrier 71 is embodied particularly as a filter mat made of a stainless steel mesh through which fluid such as extinguishing fluid can penetrate but which, on the other hand, prevents flames from penetrating through in the direction of the collection region 70.

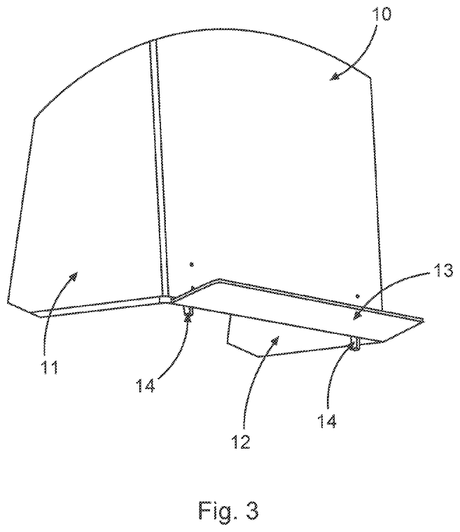

FIG. 3 shows a schematic front view of a front protective wall 10 according to the first embodiment which has already been explained in connection with FIGS. 1, 2A, and 2B. This means that the front protective wall 10 comprises a first side guard 11, a second side guard 12 (not shown), and a transport receiving means 13. Furthermore, the front protective wall 10 comprises receiving elements 14 in the form of pins.

As already explained in connection with FIG. 1, the front protective wall 10 comprises a transport receiving means 13 which is designed to withstand handling by a transport device using appropriate transport means. This means that, in order to enable the front protective wall 10 to be identified, a transport receiving means 13 in the form of an obliquely arranged, stable sheet metal is attached to the front side thereof. As a result, a means of transport of a transport device—e.g., the fork of a forklift—can be guided beneath the storage container 80 on which the front protective wall 10 is arranged and transport the storage container together with the front protective wall 10.

In order to simplify potential transport even further, the front protective wall 10 can also be arranged on the storage container 80 so as to be displaceable, particularly in such a way that the front protective wall 10 is slightly raised in the vertical direction due to the fact that the transport means is guided along the transport receiving means 13. It should be understood here that, in a case in which the device 1, 1′ is already arranged in the storage assembly 100, there may also be other options for identifying the front protective wall 10 even without the transport receiving means 13. For this purpose, the transport means of the transport device could be used to approach the front protective wall 10 from below and/or in a combined vertical and horizontal movement and thus raise the front protective wall 10.

The front protective wall 10 of FIG. 3 further comprises two receiving elements 14 in the form of two pins. These receiving elements 14 serve to cooperate with the fluid-permeable platform during the arrangement of the storage container 80 on which the front protective wall 10 is to be arranged in order to hold the front protective wall 10 in position in order to prevent the front protective wall 10 from being pushed away by the liquid pressure occurring in the event of a sudden leakage of liquid hazardous material from the storage container 80. This would cause the front protective wall to lose its effectiveness.

In the embodiment of FIG. 3, the receiving elements 14 are embodied as pins that are designed to engage with one another in the grate which forms the fluid-permeable platform 50. This results in increased security in terms of the positioning of the storage container 80 in the storage assembly.

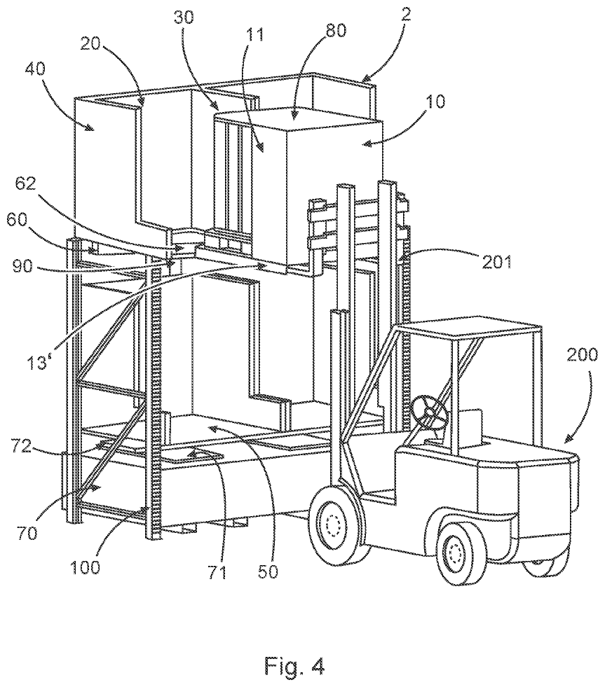

FIG. 4 shows a schematic and exemplary view of a schematic layout of a storage system comprising at least one device 2 for securely storing liquid hazardous material according to a second embodiment and a storage assembly 100. The device 2 according to the second embodiment of FIG. 4 has the same functionalities as the device 1, 1′ according to the first embodiment, with same reference numbers referring to same components.

Here too, the device 2 again comprises a housing for a storage container 80 comprising a front protective wall 10 that is arranged on the storage container 80, a rear protective wall 20, as well as a first side protective wall 30, a second side protective wall 40, and a fluid-permeable platform 50. The rear protective wall 20, the first side protective wall 30, and the second side protective wall 40 can be connected to one another by means of a dimensionally stable frame element. In some embodiments, this dimensionally stable frame element can be a frame element that is provided specifically for this purpose. In some embodiments, the dimensionally stable frame element can also be formed by a transport receiving means 13′, as will be described below.

The fluid-permeable platform 50 according to the second embodiment of FIG. 4 is again embodied as a grating. This allows for better placement of the storage container 80 within the storage assembly 100 without requiring precise alignment of the storage container 80.

The device 2 further comprises a discharge surface 60 which serves to channel any liquid hazardous material that has escaped from the storage container 80 into a fluid conduit system 90 of the device 2, the fluid conduit system 90 serving to channel the liquid hazardous material into the collection region 70 beneath the devices 2, as explained in connection with FIGS. 1 to 3. Here, the discharge surface 60 has a relatively large intake volume for the liquid hazardous material which serves as a buffer in the event that a large amount of liquid hazardous material suddenly emerges from the storage container 80 which cannot be drained away immediately and completely via the fluid conduit system.

Furthermore, since the fluid-permeable platform 50 is embodied as a grating, it enables any liquid hazardous material that has escaped from the storage container 80 to be guided promptly to the discharge surface 60 and thus effect a rapid drainage of the liquid hazardous material from the housing.

Also in the case of the second embodiment according to FIG. 4, the discharge surface 60 again serves as a buffer for the escaping liquid hazardous material. For this purpose, the discharge surface 60 further comprises at least one second flame arrester 62, which serves as an additional protective barrier in the event of a fire. As mentioned above, the liquid hazardous material passes from the discharge surface 60 into the fluid conduit system 90. Here, the fluid conduit system 90 comprises one or more pipes via which the liquid hazardous material is guided in the direction of the collection region 70. It should be mentioned here that the length of the pipes used for this purpose can vary depending on the height of the storage assembly 100. This means that, in the case of especially tall storage assemblies 100, longer tubes are required for the highest mounted devices 2 than for the devices in the lower region of the storage assembly 100. In the case of devices 2 that are arranged in the lowest level of the storage assembly 100—i.e., directly above the collection region 70—a pipe can even be dispensed with in some embodiments, and the liquid hazardous material from this level can be guided directly into the collection region 70.

In the embodiment of FIG. 4, the storage assembly 100 is embodied with two levels. Although not visible in FIG. 4, the fluid conduit system 90 arranged on the rear of the storage assembly 100 is designed to conduct both the liquid hazardous material from the lower and upper levels into the collection region 70 via appropriate pipes. In this respect, too, the second embodiment of FIG. 4 corresponds to the first embodiment of FIGS. 1 to 3, in which a fluid conduit system 90 with pipes was also described.

Another difference between the second embodiment of FIG. 4 and the first embodiment of FIGS. 1 to 3 is that the front protective wall 10 arranged on the storage container 80 is embodied as a receiving carriage for the storage container 80.

In the second embodiment as well, the front protective wall 10 comprises a first side guard 11 and a second side guard 12. The front protective wall 10 and the first side guard 11, as well as the second side guard 12, are also connected to one another by means of a dimensionally stable frame element, such as a metal frame. In the second embodiment, the front protective wall 10, the first side guard 11, and the second side guard 12 each comprise, in particular, a metal sheet which is respectively mounted on a stable metal frame. In some embodiments, a specially provided stable metal frame can be used for this purpose. Alternatively or in addition, the transport receiving means 13′ can also be used as a stable metal frame if it is designed accordingly.

The front protective wall 10 according to the second embodiment further comprises corresponding transport receiving means 13′, which are embodied as fork pockets in the second embodiment. These fork pockets are designed such that they are only open toward the front side of the storage container 80 and are closed at the other end thereof. This prevents any liquid hazardous material that has escaped from the storage container and reached the fluid-permeable platform 50 from being conducted forward through the fork pockets and hence from flowing forward out of the storage assembly 100.

FIG. 4 also shows a transport device 200 which, in the specific embodiment of FIG. 4, is embodied as a forklift. The transport device 200 comprises a transport means 201 which, in the specific embodiment of FIG. 4, is embodied as a fork of the forklift. As shown in FIG. 4, the device 2 can be lifted from the ground by means of the transport device 200 and arranged in the storage assembly 100. For this purpose, in the embodiment of FIG. 4, the transport means 201—i.e., the fork of the forklift—engages in the transport receiving means 13′—i.e., the fork pockets that are arranged on the front protective wall 10—and thus enables lifting, moving, arranging, or the like of the storage container 80. It should be mentioned here that the arrangement according to the second embodiment can have the effect that there is no good view of the remaining components of the device 2 during insertion of the storage container 80 with the front protective wall 10, because the storage assembly 100 can block the view. Therefore, the use of a grating as a fluid-permeable platform 50 is also advantageous here, as this allows the storage container 80 not to have to be positioned so precisely.

In the second embodiment of FIG. 4, a second discharge surface (not shown) can also be arranged beneath the storage container 80 and connected to the housing and/or the transport receiving means 13′, so that the second discharge surface is connected to the storage container 80 and the front protective wall 10 can be inserted into the storage assembly 100. In particular, the second discharge surface can be provided between the fork pockets here. The second discharge surface can be provided particularly for the purpose of channel any liquid hazardous material that has escaped from the storage container 80 into the rear area of the housing for the storage container 80 and hence in the direction of the fluid conduit system 90 and away from the front side of the storage assembly 100. It can also be used as a storage space for storage containers of a type other than the storage containers 80 that are filled with flammable hazardous material.

As shown in FIG. 4, a provision is made according to the second embodiment that the rear protective wall 20, the first side protective wall 30, and the second side protective wall 40 as well as the fluid-permeable platform 50 are suspended in the storage assembly 100, particularly two crossmembers of the storage assembly 100, with the effect that storage assembly levels such as shelf levels are no longer necessary.

For this purpose, the size of the device 2 can be selected particularly such that that the device 2 can be inserted into a commercially available storage assembly 100. In the embodiment of FIG. 4, such a commercially available storage assembly 100 is, for example, a commercially available pallet rack with a width of 270 cm. Two devices 2 can now be arranged in this commercially available pallet rack. This means that the width of the devices 2 must be selected such that two devices fit next to one another in the pallet rack. Furthermore, the height must be selected such that two devices 2 can be arranged one above the other in the pallet rack. This makes it possible to retrofit commercially available pallet racks in existing hazardous materials warehouses without much effort.

Finally, the device 2 according to the second embodiment again comprises a collection region 70 which, in the second embodiment according to FIG. 4, is provided as a collection trough in the form of a steel container having a receiving volume which is preferably determined like in connection with FIGS. 1 to 3. The steel container can, in particular, be galvanized. Loose metal sheets can be placed on the collection region 70—i.e., on the steel container—which make it possible to clean the collection region 70 regularly without much effort.

In the second embodiment according to FIG. 4, the collection region 70 also comprises one or more first flame arresters 71. The collection region 70 preferably comprises two flame arresters 71 per device 2 with which the collection region 70 is associated. Here, these two flame arresters are each arranged centrally beneath the housing of the device 2, particularly in such a way that liquid hazardous material that has escaped from the fluid conduit system 90 first reaches the first flame arresters 71 before it can reach the collection region 70. This can ensure that burning liquid hazardous material that is conducted via the fluid conduit system 90 in the direction of the collection region 70 is not simply added to liquid hazardous material that may already be in the collection region 70, but rather is first passed over the first flame arrester 71, thus preventing the flames from spilling over between the fluid conduit system 90 and the collection region 70.

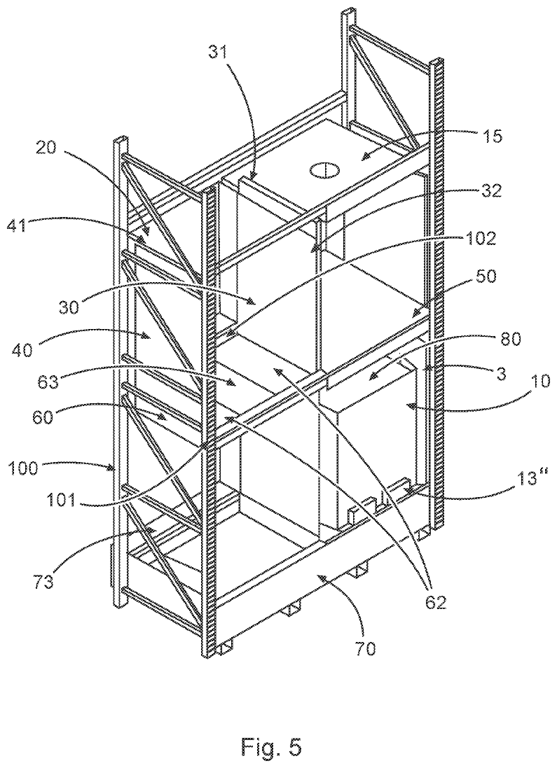

FIG. 5 shows a schematic and exemplary view of a layout of a device 3 for securely storing liquid hazardous material according to a third embodiment of the invention. Here as well, same components are again denoted by same reference numerals. In the third embodiment, too, the device 3 comprises a rear protective wall 20, a first side protective wall 30, and a second side protective wall 40, as well as a fluid-permeable platform 50 which, together with a front protective wall 10, form a housing for a storage container 80. Also in the third embodiment according to FIG. 5, the rear protective wall 20, the first side protective wall 30, and the second side protective wall 40 can be made of metal.

The fluid-permeable platform 50 is formed by a grating in the third embodiment according to FIG. 5. The design as a grating offers the dual advantage that the device 3 does not have to be arranged so precisely while also reducing the probability that the storage container will fall over when it is inserted into the storage assembly.

In the third embodiment according to FIG. 5, the device 3 also comprises a discharge surface 60 which is arranged beneath the fluid-permeable platform 50. The discharge surface 60 has a relatively large intake volume which serves as a buffer in the event that a large amount of liquid hazardous material suddenly emerges from the storage container 80 which cannot be drained away immediately and completely via the fluid conduit system.

In the third embodiment according to FIG. 5, the device 3 further comprises connecting elements 31, 41 and an insert plate 63 which is arranged on the discharge surface 60 and serves to conduct any liquid escaping from the storage containers 80 through the flame arresters 62 of the discharge surface 60 into the fluid conduit system of the device 3.

A suspension arrangement is also arranged on the device 3 according to the third embodiment which enables the device 3 to be suspended in a partially assembled state into the storage assembly 100—particularly in a completely assembled state except for the front protective wall 10. For this purpose, the rear protective wall 20, the first side protective wall 30, the second side protective wall 40, the fluid-permeable platform 50, the discharge surface 60 with the insert plate 63 and the connecting elements 31, 41 are mounted on the suspension arrangement and hung as a unit in the storage assembly 100. Here, the suspension arrangement is embodied such that it is suitable for hanging in a commercially available storage assembly 100, such as a pallet rack. This means that the dimensions of the suspension arrangement are selected such that they can interact with the struts of a commercially available storage assembly 100 in order to hold the device 3.

The device 3 according to the third embodiment of FIG. 5 differs from the devices according to the first and second embodiments according to FIGS. 1 to 4 inter alia through the design of the fluid conduit system. While the fluid conduit system was provided by corresponding pipes in the previous embodiments, the device 3 according to the third embodiment comprises a first side protective wall 30 and a second side protective wall 40 which are double-walled in order to form the fluid conduit system according to the third embodiment. This means that the first side protective wall 30 and the second side protective wall 40 are designed such that a cavity 32 is provided between a first wall and a second wall of the first side protective wall 30 and a cavity 42 (not shown in FIG. 5) is provided between a first wall and a second wall of the second side protective wall 40. In order to enable efficient conduction of fluid to be provided through the fluid conduit system, the distance between the first wall and the second wall of the first side protective wall 30 and the distance between the first wall and the second wall of the second side protective wall are selected such that the area cross section of the cavities 32, 42 corresponds to the area cross section of a pipe used in other embodiments for the fluid conduit system. In some embodiments, the area cross section of the cavities 32, 42 can be selected particularly so as to correspond to that of a pipe with a diameter of between 200 and 300 mm, more specifically between 220 and 280 mm, even more specifically of about 270 mm.

The double-walled first side protective wall 30 and the double-walled second side protective wall 40 each have an inlet opening which is designed to introduce a fluid into the cavities 32, 42, and each has an outlet opening which is set up in the cavities 32, 42 to output fluid in the direction of the collection region 70 and/or in the direction of another cavity 32, 42 of another device 3.

In other words, in the third embodiment according to FIG. 5, the cavities 32, 42 in the first side protective wall and the second side protective wall are utilized in order to provide the fluid conduit system between the discharge surfaces 60 of the devices 3 and the collection region or regions 70 of the devices 3.

For this purpose, the first side protective wall 30 and the second side protective wall 40 are arranged on the sides of the discharge surface 60. The discharge surface 60, in turn, has fluid outlet openings which are arranged so as to each be situated exactly above the inlet openings into the cavity 32 of the first side protective wall 30 and the cavity 42 of the second side protective wall 40 of a second device 3 that is arranged within the storage assembly 100 beneath a first device 3, so that the fluid that is guided onto the discharge surface 60, particularly the liquid hazardous material, is guided from the discharge surface 60 of the upper, first device 3 into the cavities 32, 42 of the first side protective wall 30 and the second side protective wall 40. Here, the inlet openings and the outlet openings of the cavities 32, 42 in the first side protective wall 30 and the second side protective wall 40 are embodied such that they always conduct a fluid, particularly the liquid hazardous material, to the respective fluid outlet openings of the discharge surfaces 60 in order to thus prevent the liquid hazardous material that is guided through the cavities 32, 42 from accumulating on a discharge surface 60 of a subjacent device 3 instead of being guided further toward the collection region 70.

Fluid can thus be guided over multiple levels of the storage assembly 100 from top to bottom through a fluid conduit system that is formed by the first side protective wall 30 and the second side protective wall 40 in the direction of a collection region beneath the storage assembly 100. Additional pipes need not be provided.

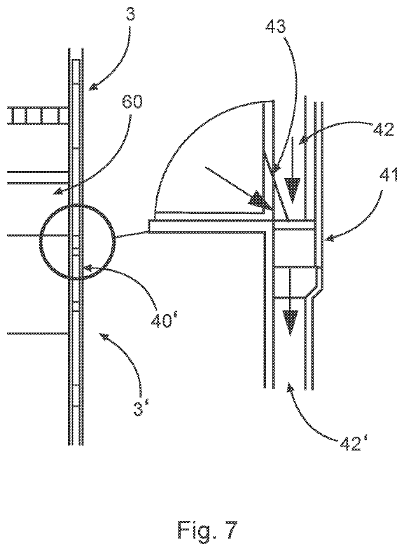

The connecting elements 31, 41 are provided here in order to ensure a fluid-tight connection between the cavities 32, 42 of the first side protective wall 30 and the second side protective wall 40 of the devices 3. These connecting elements 31, 41 are designed to cooperate with the discharge surface 60 of a first device 3 and with a first side protective wall 30 and second side protective wall 40 of a second device 3 that is arranged in a storage assembly 100 beneath the first device 3 in order to establish a fluid-tight connection between the discharge surface of the first device 3 and the cavities 32, 42 of the first side protective wall 30 and the second side protective wall 40 and thereby seal the fluid conduction system in a fluid-tight manner. The connecting elements 31, 41 can be preferably embodied as insertable plug-in connections which can be plugged onto the first side protective wall 30 and the second side protective wall 40 as well as an edge of the discharge surface 60, as is depicted again in detail in connection with FIG. 7. The device 3 can then be inserted into the storage assembly 100. After insertion, the connecting elements 31, 41 can then be brought into fluid communication with the discharge surface 60.

The design of the connecting elements 31, 41 as flexible plug-in connections has the advantage that the flexibility of the storage assembly 100 is maintained by these flexible plug-in connections, which reduces the likelihood of damage when heavy loads are inserted.

In the third embodiment according to FIG. 5, it is preferred that a collection region 70 be associated with a plurality of devices 3. In other embodiments, however, one collection region can also be provided per device 3 or devices 3 that are arranged one above the other, with adjacently arranged devices 3 having different collection regions 70.

The collection region 70 according to the third embodiment of FIG. 5 corresponds to a collection trough which is arranged directly beneath the devices 3 on a floor surface or another surface on which the storage assembly 100 is also set up. The dimensions of the collection region 70 are thus adapted to the length and width of the storage assembly 100. The storage volume of the collection region 70 is also selected such that the collection region is able to completely receive the contents of at least one storage container 80 while also accommodating appropriately applied extinguishing fluid. The specific embodiment of FIG. 5, for example, is a pallet rack with a width of 270 cm and a volume of 1400 liters, with 1000 liters thereof corresponding to the contents of the storage container 80—and thus to the liquid hazardous material—and 400 liters corresponding to extinguishing fluid that is applied.

As an additional measure to ensure that no liquid hazardous material gets out of the collection region 70 and is distributed over the storage region, the collection regions 70 of a plurality of storage assemblies 100—i.e., adjacently arranged collection regions 70—can be connected to one another in a fluid-conducting manner, thus enabling fluid to flow from one collection region 70 into the next if necessary. The connection can be established particularly by means of corresponding connection elements (not shown). The connection elements can also be used to safely remove fluid located in the collection region 70.

In the embodiment according to FIG. 5, the collection trough, which serves as a collection region 70, is equipped with reinforcing elements which have the same shape and position as the crossmembers of the storage assembly 100. This type of reinforcement by means of appropriate reinforcing elements enables the device 3 to be arranged on the lowest level of the storage assembly directly on the collection region 70 without the need to provide additional holders in the storage assembly 100. This relieves the load on the storage assembly 100, since it does not have to bear the load of the storage containers 80 that are arranged on the lowest level.

In the third embodiment as well, the collection region 70 has one or more first flame arresters 71 (not shown) which serve to separate the storage container 80 or discharge surface 60 and the liquid hazardous material in the collection region 70 in the event of a fire.

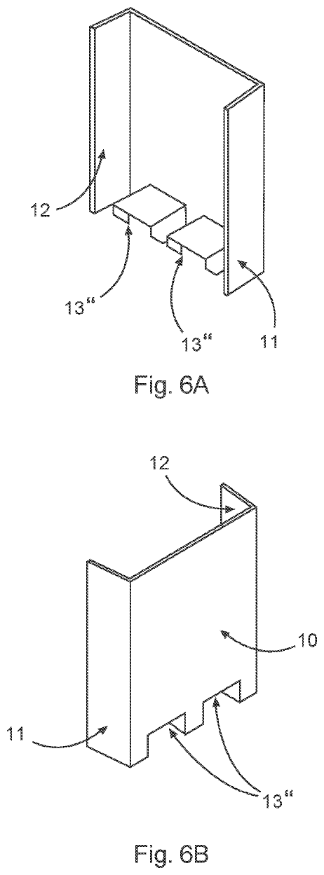

In the third embodiment, too, the housing of the device 3 is formed by arranging the storage container 80 with a front protective wall 10 arranged thereon in the storage assembly 100. For this purpose, the front protective wall 10 comprises a first side guard 11 and a second side guard 12, as is shown schematically in FIGS. 6A and 6B, for example.

In order to enable the storage container 80 to be transported together with the front protective wall 10 arranged thereon and, in particular, enable it to be arranged in the storage assembly 100, the front protective wall 10 according to the third embodiment has corresponding transport receiving means 13″ which are designed to cooperate with a transport means 201 of a transport device 200 for the purpose of arranging the storage container 80 together with the front protective wall 10 in the storage assembly 100. Here, the storage container 80 is arranged on the fluid-permeable platform 50, as shown in FIG. 5. The first side guard 11 and the second side guard 12, together with the front protective wall 10, prevent liquid hazardous material from escaping over the front side of the storage container 80. Instead, the liquid hazardous material is diverted toward the rear side in such a case. Furthermore, since the storage container 80 is arranged on a fluid-permeable platform 80, the liquid hazardous material reaches the discharge surface 60 and then the collecting basin 70 even if it exits via the front side.

In this connection, schematic and exemplary FIGS. 6A and 6B show a detailed rear view and front view of a front protective wall according to the third embodiment. As in the first embodiment and the second embodiment, the first side guard 11 and the second side guard 12 extend in an orthogonal direction relative to the plane formed by the front protection wall 10 and thus extend parallel to the side surfaces of a storage container 80 on which the front protective wall 10 is arranged.

The difference to the first and second embodiments in the third embodiment lies in the design of the transport receiving means 13″ and in the manner in which the front protective wall 10 can be arranged on the storage container 80. In the third embodiment, the front protective wall 10 is designed to be arranged on the storage container 80 without having to lift the storage container 80 for this purpose. This means that the front protective wall 10 can even be arranged manually on the storage container 80.

For this purpose, the transport receiving means 13″ is designed to be rectangular, particularly such that it can interact with a storage device arranged beneath the storage container 80, such as a pallet. This means that the rectangular area of the transport receiving means 13″ corresponds in size at least to the rectangular area that is also provided for a fork pocket.

The front protective wall 10 can simply be pushed onto the storage container 80 and then attached. By virtue of the design of the transport receiving means 13″ as rectangles with the cross section of at least fork pockets, it is possible to easily drive under the storage containers 80 with a transport device such as a forklift and thus pick them up for transport even with the front protective wall mounted in place.

In order to prevent liquid hazardous material from flowing through possible openings in the storage container 80 toward the front side of the arrangement and thus possibly leaking out, discharging means oriented in the direction of the storage container 80 are arranged on the edges of the transport receiving means 13″ and have an angular U-profile and thus fit with the rectangular shape of the transport receiving means 13″. Another advantage of this embodiment is that the front protective walls 10 can be stored in a space-saving manner before being arranged on the storage containers 80 by stacking them on top of one another and inserting them into one another, as it were. The dimensions of the front protective walls 10 according to the third embodiment can be selected particularly such that a stack of ten front protective walls 10 takes up approximately the space of a storage container when stored.

In order to enable the front protective wall 10 to be arranged as easily as possible on a storage container 80, the front protective wall 10 may further comprise one or more handles (not shown in FIGS. 6A and 6B) into which a fitter can reach. Furthermore, in order to ensure the attachment of the front protective wall 10, corresponding brackets or latches (also not shown in FIGS. 6A and 6B) can be provided with which the front protective wall can be fastened to the storage container 80.

FIG. 7 shows a schematic and exemplary view of a connecting element 41 according to the third embodiment. The connecting element 41 is designed to connect, in a fluid-tight manner, the discharge surface 60 and the cavity 42 of a first device 3 to the cavity 42′ of a second side protective wall 40′ of a second device 3′ that is arranged in a storage assembly 100 beneath the first device 3. For this purpose, the connecting element 41 is embodied as a plug-in connection element which is arranged in the second side protective wall 40′ but not attached thereto.

The first device 3 and the second device 3′ are now first suspended one beneath the other in the storage assembly 100 using their respective suspension frames. This hanging causes an outlet of the discharge surface 60 and the cavity 42 of the first device 3 to be arranged above an inlet opening of the cavity 42′ of the second side protective wall 40′ of the second device 3′. As mentioned above, the connecting element 41 is located in the second side protective wall 40′ when it is hung and is therefore hung together with the latter. After hanging, the connecting element 41 is pushed upward in the direction of the discharge surface 60 and connected to the discharge surface 60. This creates a closed fluid conduit system between the cavity 42 of the first device 3 and the cavity 42′ of the second device 3′.

As is also shown in FIG. 7, the cavity 42 of the first device 3 is designed such that it has an inclined protective wall 43 at the point at which the outlet of the discharge surface 60 and the outlet of the cavity 42 are connected to the inlet opening of the cavity 42 which is tapered such that it narrows the outlet of the cavity 42 along the direction of flow of the fluid that is conducted through the cavity 42 toward the inlet opening of the cavity 42. This narrowing prevents the fluid from traveling from the cavity 42 of the second device 3′ into the cavity 42 and/or onto the discharge surface 60 of the first device 3.

The bevel that is formed by the inclined protective wall 43 is preferably dimensioned such that it fits the requirements of the respective devices 3. In particular, the length over which the bevel extends along the direction of flow of the fluid being conducted through the cavity 42 and the distance between the bevel and the opposite (inner) wall of the second side protective wall 40 can be selected such that the flow from the cavity 42 in the direction of the cavity 42′ can occur reliably but without the likelihood of backflow. In some embodiments, the inclined protective wall 43 can be embodied particularly such that it decreases the width between the first and second (inner) walls of the second side protective wall by 20% to 60%, more specifically by 30% to 50%, even more specifically by 40%.

In a specific embodiment, the cavity can, for example, have a width—i.e., a distance from the first wall to the second wall of the second side protective wall 40—of 50 mm, with the inclined protective wall 43 extending such that it is 50 mm from the oppositely situated inner wall of the cavity 42 at its starting point and is 30 mm away from the oppositely situated inner wall of the cavity 42 at its end point.

The length of the inclined protective wall 43 between the starting and end points can be selected accordingly. In some embodiments, the inclined protective wall 43 can, in particular, have a length of from 1 mm to 30 mm, more specifically from 5 mm to 30 mm, even more specifically from 10 mm to 30 mm, particularly 10 mm, 15 mm, 20 mm, 25 mm, or a value therebetween. Other dimensions are also conceivable, as long as they satisfy the above features of allowing flow and preventing backflow.

### LIST OF REFERENCE NUMERALS

storage device 1, 1′, 2, 3
front protective wall 10
side guard 11, 12
transport receiving means 13, 13′, 13″
receiving elements 14
heat protection 15
rear protective wall 20
first side protective wall 30
second side protective wall 40, 40′
connecting element 31, 41
cavity 32, 42, 42′
fluid-permeable platform 50
discharge surface 60
inclined surface 61
second flame arrester 62
insert plate 63
collection region 70
first flame arrester 71
collection region splash guard 72
storage container 80
pallet 81
fluid conduit system 90
storage assembly 100
bearing crossmember 101
bearing fixture 102
transport device 200
transport means 201

1. A device for securely storing liquid hazardous material, comprising:
a housing which is designed to receive a storage container for the liquid hazardous material, the housing comprising:
a rear protective wall which is designed to protect a rear side of the storage container,
a first lateral protective wall and a second lateral protective wall which are designed to protect two side walls of the storage container,
a front protective wall which is designed to protect a front side of the storage container; and
a fluid-permeable platform which is designed as a supporting surface for the storage container within the device;
a collection region which is fluidically connected to an inner region of the housing;
wherein the front protective wall is designed to be arranged on the storage container in order to form the housing together with the rear protective wall, the first lateral protective wall, the second lateral protective wall, and the fluid-permeable platform when the storage container is received in the device, and
wherein the front protective wall comprises a transport receiving means which is designed to cooperate with a transport means for transporting the storage container.

2. The device according to claim 1, further comprising at least one discharge surface which is designed to provide at least part of a fluid-conducting connection between the inner region of the housing and the collection region.

3. The device according to claim 2, further comprising at least one fluid conduit system which is designed to provide at least part of a fluid-conducting connection between the inner region of the housing and the collection region.

4. The device according to claim 3, wherein the at least one discharge surface has a slope in the direction of the fluid conduit system in order to channel a fluid in the direction of the fluid conduit system.

5. The device according to claim 1, wherein the front protective wall further comprises at least one side guard which is designed to extend along at least one side surface of the storage container.

6. The device according to claim 1, wherein one or more from among the rear protective wall, the first side protective wall, the second side protective wall, the front protective wall, and the fluid-permeable platform are made of a non-combustible material.

7. The device according to claim 1, further comprising at least one first flame arrester, the at least one first flame arrester being arranged between the fluid-permeable platform and the collection region.

8. The device according to claim 7, further comprising at least one second flame arrester, the at least one second flame arrester being arranged between the fluid-permeable platform and the at least one discharge surface.

9. The device according to claim 8, wherein at least one from among the first flame arrester or the second flame arrester is formed as a siphon and/or as a grate.

10. The device according to claim 1, wherein the collection region has a first intake volume (VAU), the first intake volume (VAU) being determined as VAU=VL+VS, where VL corresponds to a storage volume of the storage container and VS corresponds to a specified safety volume.

11. The device according to claim 10, wherein at least one discharge surface has a second intake volume (VAL), the second intake volume (VAL) being smaller than the first intake volume (VAU).

12. The device according to claim 3, wherein one or more from among the first side protective wall and the second side protective wall are double-walled with an interposed cavity, the cavity being designed to form at least a portion of the fluid conduit system, and the cavity being further designed to conduct extinguishing fluid that has escaped from the storage container in the direction of the collection region and/or of the at least one discharge surface.

13. A storage system for storing liquid hazardous material, comprising:
a plurality of devices according to claim 1, and
a storage assembly which is designed to receive the plurality of devices for storage.

14. The storage system for storage according to claim 13, wherein two or more of the plurality of devices comprise at least one first side protective wall and one second side protective wall, wherein one or more from among the first side protective wall and the second side protective wall are double-walled with an interposed cavity, wherein the cavity is designed to form at least a portion of a fluid conduit system, and wherein the cavity is further designed to conduct extinguishing fluid that has escaped from the storage container in the direction of a collection region and/or of at least one discharge surface, and
a storage assembly which is designed to accommodate the plurality of devices for storage;
wherein at least one first device from among the plurality of devices is arranged relative to a floor surface above a second device from among the plurality of devices, the storage system comprising at least one connecting element which is designed to connect the discharge surface of the first device to the cavity of the second device in a fluid-tight manner.

15. A fire protection system, comprising:
at least one storage system comprising at least one device according to claim 1,
at least one extinguishing fluid supply with at least one extinguishing fluid supply line, and
a plurality of extinguishing fluid outlets, the plurality of extinguishing fluid outlets being designed to output an extinguishing fluid to the at least one device in the event of a fire.

16. A method for storing a device for securely storing liquid hazardous material, comprising:
providing a housing which is designed to receive a storage container for the liquid hazardous material, the housing comprising a rear protective wall which is designed to protect a rear side of the storage container, a first side protective wall and a second side protective wall which are designed to protect two side walls of the storage container, a front protective wall which is designed to protect a front side of the storage container, and a fluid-permeable platform which is designed as a supporting surface for the storage container within the device;
providing a collection region which is fluidically connected to an inner region of the housing;
arranging the front protective wall on the storage container,
transporting the storage container together with the front protective wall to a storage position by means of a transport means which cooperates with a transport receiving means of the front protective wall,
forming the housing of the front protective wall together with the rear protective wall, the first side protective wall, the second side protective wall and the fluid-permeable platform by inserting the storage container with the front protective wall arranged thereon into the device.
